(19) United States
(12) Patent Application Publication
(10) Pub. No.: US 2004/0044765 A1
(43) Pub. Date: Mar. 4, 2004

(54) Method and system for identifying lossy links in a computer network

(75) Inventors: Christopher A. Meek, Kirkland, WA (US); Venkata N. Padmanabhan, Bellevue, WA (US); Lili Qiu, Bellevue, WA (US); Jiahe Wang, Issaquah, WA (US); David B. Wilson, Redmond, WA (US); Christian H. Borgs, Seattle, WA (US); Jennifer T. Chayes, Seattle, WA (US); David E. Heckerman, Bellevue, WA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Microsoft Corporation, Redmond, WA

(21) Appl. No.: 10/378,332

(22) Filed: Mar. 3, 2003

Related U.S. Application Data
(60) Provisional application No. 60/407,425, filed on Aug. 30, 2002.

(51) Int. Cl. G06F 15/173

(52) U.S. Cl. 709/224

(57) ABSTRACT

A computer network has links for carrying data among computers, including one or more client computers. Packet loss rates are determined for the client computers. Probability distributions for the loss rates of each of the client computers are then developed using various mathematical techniques. Based on an analysis of these probability distributions, a determination is made regarding which of the links are excessively lossy.

### RELATED ART

This application is based on provisional application No. 60/407,425, filed Aug. 30, 2002, entitled “Method and System for Identifying Lossy Links in a Computer Network.”

### TECHNICAL FIELD

The invention relates generally to network communications and, more particularly, to methods and systems for identifying links in a computer network that are experiencing excessive data loss.

### BACKGROUND

Computer networks, both public and private, have grown rapidly in recent years. A good example of a rapidly growing public network is the Internet. The Internet is made of a huge variety of hosts, links and networks. The diversity of large networks like the Internet presents challenges to servers operating in such networks. For example, a web server whose goal is to provide the best possible service to clients must contend with performance problems that vary in their nature and that vary over time. Performance problems include, but are not limited to, high network delays, poor throughput and high incidents of packet losses. These problems are measurable at either the client or the server, but it is difficult to pinpoint the portion of a large network that is responsible for the problems based on the observations at either the client or the server.

Many techniques currently exist for measuring network performance. Some of the techniques are active, in that they involve injecting data traffic into the network in the form of pings, traceroutes, and TCP connections. Other techniques are passive in that they involve analyzing existing traffic by using server logs, packet sniffers and the like. Most of these techniques measure end-to-end performance. That is, they measure the aggregate performance of the network from a server to a client, including all of the intermediate, individual network links, and make no effort to distinguish among the performance of individual links. The few techniques that attempt to infer the performance of portions of the network (e.g., links between nodes) typically employ “active” probing (i.e., inject additional traffic into the network), which places an additional burden on the network.

### SUMMARY

In accordance with the foregoing, a method and system for identifying lossy links in a computer network is provided. According to various embodiments of the invention, the computer network has links for carrying data among computers, including one or more client computers. Packet loss rates are determined for the client computers. Probability distributions for the loss rates of each of the client computers are then developed using various mathematical techniques. Alternatively, packet loss rates can be expressed as “packet loss statistics,” which are the success and failure counts rather than the loss rate. The “packet loss rate” is the ratio of the failure rate to the “total” rate of packets, where the total rate is the sum of the success (s) and failure (f) rates. Therefore, the packet loss rate equals f/(s+f). Based on an analysis of these probability distributions, a determination is made regarding which of the links is excessively lossy.

Additional aspects of the invention will be made apparent from the following detailed description of illustrative embodiments that proceeds with reference to the accompanying figures.

### BRIEF DESCRIPTION OF THE DRAWINGS

While the appended claims set forth the features of the present invention with particularity, the invention may be best understood from the following detailed description taken in conjunction with the accompanying drawings of which:

FIG. 1 illustrates an example of a computer network in which the invention may be practiced;

FIG. 2 illustrates an example of a computer on which at least some parts of the invention may be implemented;

FIG. 3 illustrates a computer network in which an embodiment of the invention is used;

FIG. 4 illustrates programs executed by a server in an embodiment of the invention;

FIG. 5 illustrates the probability distribution of the observed losses with all link loss rates fixed except for lᵢ;

FIG. 6 illustrates the probability distributions P (lₙ|ID) for each value of n; and

FIG. 7 is a flowchart illustrating the procedure carried out by an analysis program according to one embodiment of the invention.

### DETAILED DESCRIPTION

Prior to proceeding with a description of the various embodiments of the invention, a description of the computer and networking environment in which the various embodiments of the invention may be practiced will now be provided. Although it is not required, programs that are executed by a computer may implement the present invention. Generally, programs include routines, objects, components, data structures and the like that perform particular tasks or implement particular abstract data types. The term “program” as used herein may connote a single program module or multiple program modules acting in concert. The term “computer” as used herein includes any device that electronically executes one or more programs, such as personal computers (PCs), hand-held devices, multi-processor systems, microprocessor-based programmable consumer electronics, network PCs, minicomputers, mainframe computers, consumer appliances having a microprocessor or microcontroller, routers, gateways, hubs and the like. The invention may also be employed in distributed computing environments, where tasks are performed by remote processing devices that are linked through a communications network. In a distributed computing environment, programs may be located in both local and remote memory storage devices.

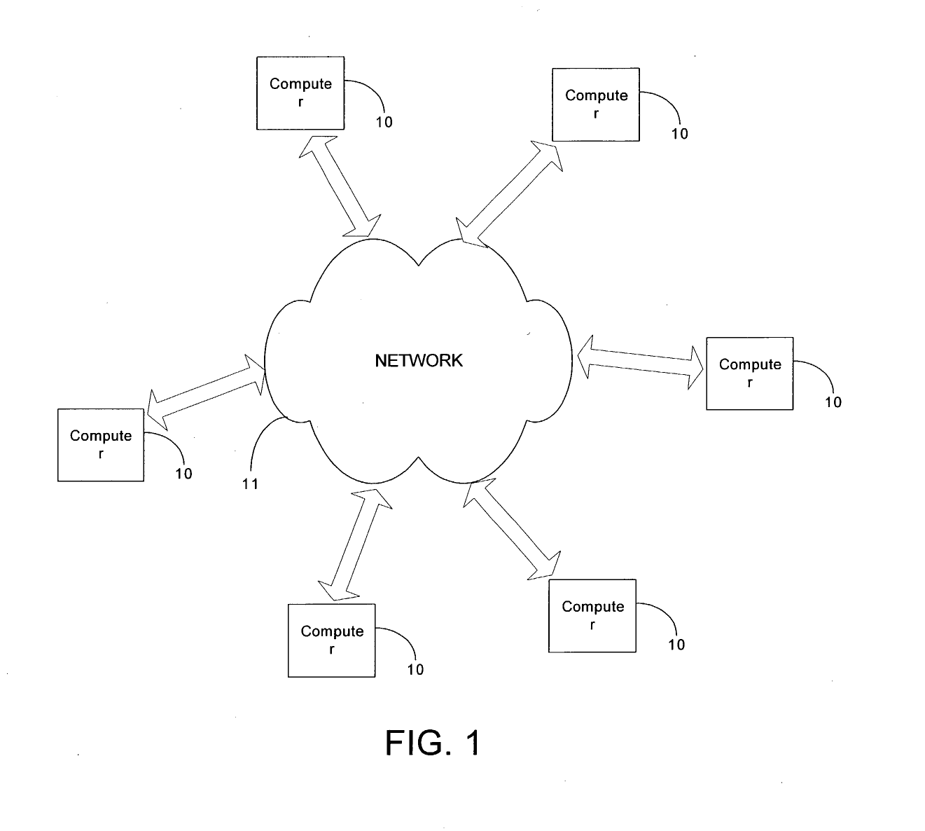

An example of a networked environment in which the invention may be used will now be described with reference to FIG. 1. The example network includes several computers 10 communicating with one another over a network 11, represented by a cloud. Network 11 may include many well-known components, such as routers, gateways, hubs, etc. and allows the computers 10 to communicate via wired and/or wireless media. When interacting with one another of the network 11, one or more of the computers may act as clients, servers or peers with respect to other computers. Accordingly, the various embodiments of the invention may be practiced on clients, servers, peers or combinations thereof, even though specific examples contained herein don't refer to all of these types of computers.

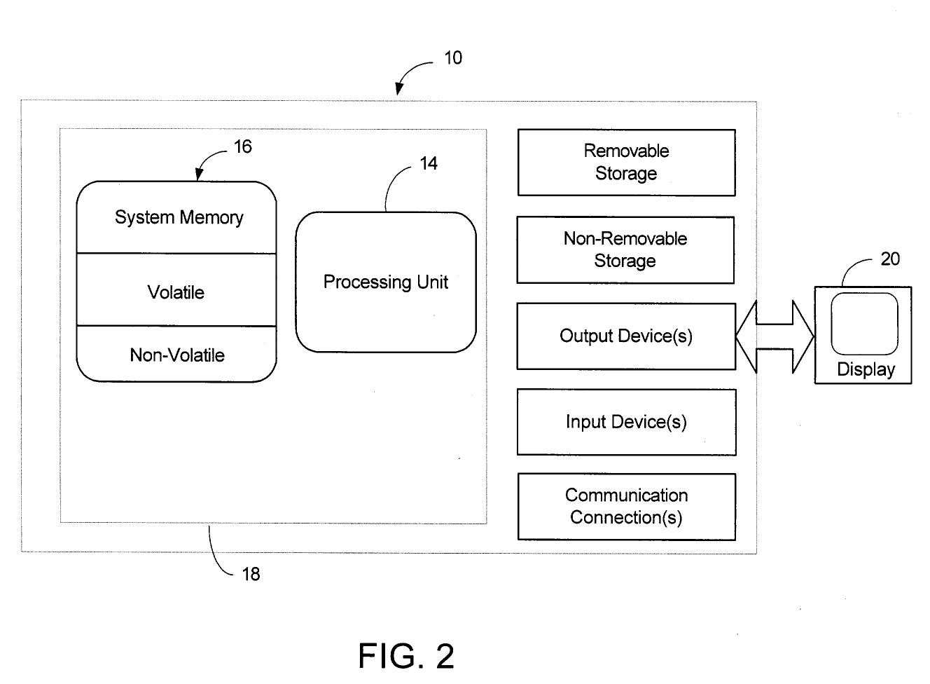

Referring to FIG. 2, an example of a basic configuration for a computer on which all or parts of the invention described herein may be implemented is shown. In its most basic configuration, the computer 10 typically includes at least one processing unit 14 and memory 16. The processing unit 14 executes instructions to carry out tasks in accordance with various embodiments of the invention. In carrying out such tasks, the processing unit 14 may transmit electronic signals to other parts of the computer 10 and to devices outside of the computer 10 to cause some result. Depending on the exact configuration and type of the computer 10, the memory 16 may be volatile (such as RAM), non-volatile (such as ROM or flash memory) or some combination of the two. This most basic configuration is illustrated in FIG. 2 by dashed line 18. Additionally, the computer may also have additional features/functionality. For example, computer 10 may also include additional storage (removable and/or non-removable) including, but not limited to, magnetic or optical disks or tape. Computer storage media includes volatile and non-volatile, removable and non-removable media implemented in any method or technology for storage of information, including computer-executable instructions, data structures, program modules, or other data. Computer storage media includes, but is not limited to, RAM, ROM, EEPROM, flash memory, CD-ROM, digital versatile disk (DVD) or other optical storage, magnetic cassettes, magnetic tape, magnetic disk storage or other magnetic storage devices, or any other medium which can be used to stored the desired information and which can be accessed by the computer 10. Any such computer storage media may be part of computer 10.

Computer 10 may also contain communications connections that allow the device to communicate with other devices. A communication connection is an example of a communication medium. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. The term “computer-readable medium” as used herein includes both computer storage media and communication media.

Computer 10 may also have input devices such as a keyboard, mouse, pen, voice input device, touch input device, etc. Output devices such as a display 20, speakers, a printer, etc. may also be included. All these devices are well known in the art and need not be discussed at length here.

The invention is generally directed to identifying lossy links on a computer network. Identifying lossy links is challenging for a variety of reasons. First, characteristics of a computer network may change over time. Second, even when the loss rate of each link is constant, it may not be possible to definitively identify the loss rate of each link due to the large number of constraints. For example, given M clients and N links, there are N constraints (corresponding to each server—end node path) defined over N variables (corresponding to the loss rate of the individual links). For each client Cⱼ, there is a constraint of the form

1− [symbol] _{iεT}_{ⱼ}(1−lᵢ)=pⱼ, (Equation 1)

where Tⱼ is the set of links on the path from the server to the client Cⱼ, lᵢ is the loss rate of link i, and pⱼ is the end-to-end loss rate between the server and the client Cⱼ. If M<N, as is often the case, there is not a unique solution to this set of constraints.

Turning again to the invention, the system and method described herein is intended for use on computer networks, and may be employed on a variety of topologies. The various embodiments of the invention and example scenarios contained herein are described in the context of a tree topology. However, the invention does not depend on the existence of a tree topology.

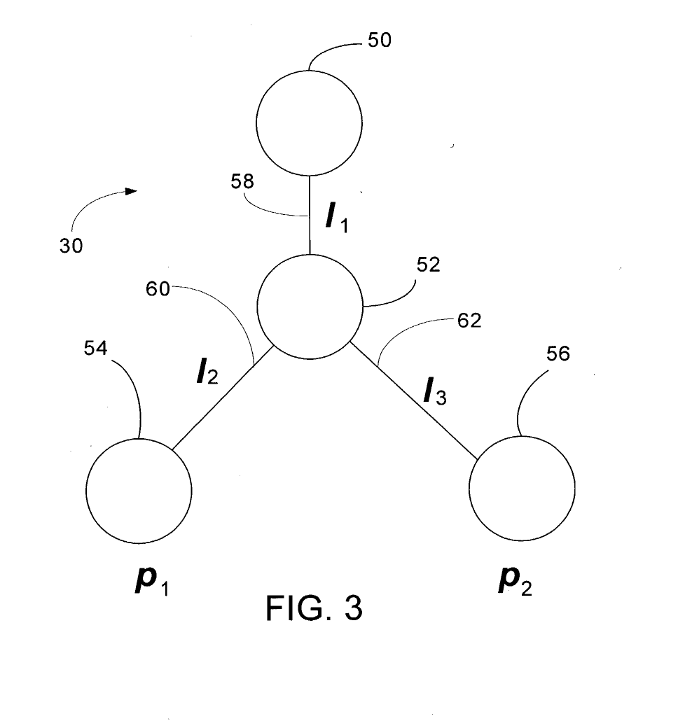

Referring to FIG. 3, a computer network 30, having a tree topology, is shown. The computer network 30 is simple, having only four nodes. However, the various embodiments of the invention described herein may be employed on a network of any size and complexity. The computer network 30 includes a server 50 and three client computers. The client computers include a first client computer 52, a second client computer 54 and a third client computer 56. The second client computer 54 and the third client computer 56 are each considered to be end nodes of the computer network 30. Each of the second client computer 54 and the third client computer 56 has a loss rate associated with it. The loss rate represents the rate at which data packets are lost when traveling end-to-end between the server 50 and the client computer. This loss rate is measured by a well-known method, such as by observing transport control protocol (TCP) packets at the server and counting their corresponding ACKs.

The network 30 also includes three network links 58, 60 and 62. Each network link has a packet loss rate associated with it. The packet loss rate of a link is the rate, on a scale of zero to one, at which data packets (e.g., IP packets) are lost when traveling across the link. As will be described below, the packet loss rate is not necessarily the actual packet loss rate for the link, but rather is the inferred loss rate for the purpose of determining whether the link is lossy.

Table 1 shows the meaning of the variables used in FIG. 3.

TABLE 1

| Variable | Meaning |
|---|---|
| l₁ | loss rate of the link 58 between the server 50 and the first |
| | client computer 52 |
| l₂ | loss rate of the link 60 between the first client computer 52 |
| | and the second client computer 54 |
| l₃ | loss rate of the link 62 between the first client computer 52 |
| | and the third client computer 56 |
| p₁ | end-to-end loss rate between the server 50 and the second |
| | client computer 54 |
| p₂ | end-to-end loss rate between the server 50 and third |
| | client computer 56 |

For any given path between the server 50 and an end node, the rate at which packets reach the end node is equal to the product of the rates at which packets pass through the individual links along the path. Thus, the loss rates in the network 30 can be expressed with the equations shown in Table 2.

TABLE 2

(1 − l₁)*(1 − l₂) = (1 − p₁)
(1 − l₁)*(1 − l₃) = (1 − p₂)

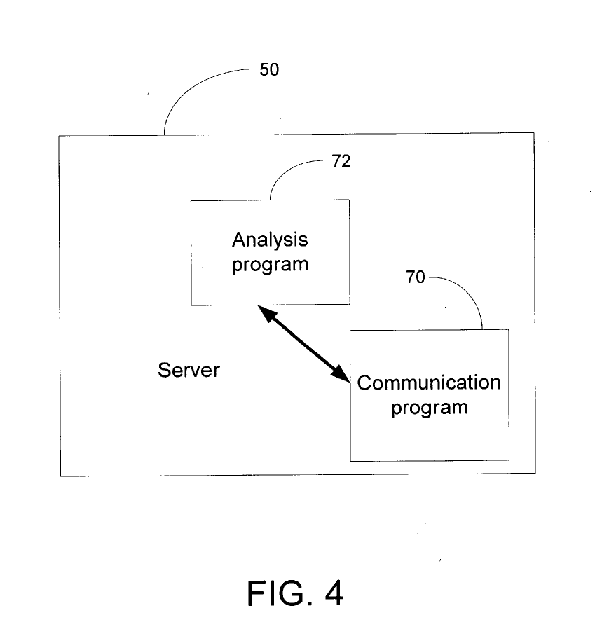

Referring to FIG. 4, a block diagram shows the programs that execute on the server 50 (from FIG. 3) according to an embodiment of the invention. The server 50 is shown executing a communication program 70 that sends and receives data packets to and from other computers in the network 30 (FIG. 3). The communication program 70 serves a variety of application programs (not shown) that also execute on the server 50. An analysis program 72 also executes on the server 50. The analysis program 72 receives data from the communication program 70. The analysis program 72 may carry out some or all of the steps of the invention, depending on the particular embodiment being used. It is to be noted that, in many embodiments of the invention, copies of the statistical analysis program 72 and communication program execute on multiple nodes of the network 30, so as to allow the monitoring and analysis of the communication on the network 30 from multiple locations.

The communication program 70 keeps track of how many data packets it sends to the each of the end nodes (the second client computer 54 and the third client computer 56 from FIG. 3). It also determines how many of those packets were lost en route based on the feedback it receives from the end nodes. The feedback may take a variety of forms, including Transport Control Protocol (TCP) ACKs and Real-Time Control Protocol (RTCP) receiver reports. The communication program 70 is also capable of determining the paths that packets take through the network 30 by using a tool such as traceroute. Although the traceroute tool does involve active measurement, it need not be run very frequently or in real time. Thus, the communication program 70 gathers its data in a largely passive fashion. Other ways in which the communication program 70 may gather data regarding the number of data packets that reach the end nodes include (for IPv4 packets), invoking the record route option (for IPv6 packets), and including an extension header for a small subset of the packets.

According to an embodiment of the invention, the analysis program 72 models the tomography of the network 30 as a Bayesian inference problem. For example, let D denote the observed data and let θ denote the (unknown) model parameters. In the context of network tomography, D represents the observations of packet transmission and loss made at end hosts, and θ the ensemble of loss rates of links in the network. The goal of Bayesian inference is to determine the posterior distribution of θ, P(θ|D), based on the observed data D. The inference is based on knowing a prior distribution P(θ) and a likelihood P(D|θ). The joint distribution P(D,θ)=P(D|θ)·P(θ). Thus, the posterior distribution of θ can be computed as follows:

$$P ( θ \vert D ) = \frac{P ( θ ) P ( D \vert θ )}{{\int }_{θ}^{} P ( θ ) P ( D \vert θ ) ⅆ θ} \qquad ( Equation 2 )$$

In general, it is difficult to compute the value of P(θ|D) directly because it involves a complex integration, especially since, when used in the context of network tomography, θ is a vector.

To model network tomography as a Bayesian inference problem, D and θ are defined as follows. The observed data, D, is defined as the number of successful packet transmissions to each client (sⱼ) and the number of failed (i.e. lost) transmissions (ƒⱼ). Thus D= [symbol] _{jεclients} [symbol] sⱼ, ƒⱼ [symbol] . The unknown parameter θ is defined as the set of links' loss rates, i.e., θ=l_{L}= [symbol] _{iεL}lᵢ, where L is the set of links in the network topology of interest. The likelihood function can then be written as

$$P ( D \vert {l}_{L} ) = {\prod }_{j ∈ clients}^{} {( 1 - {p}_{j} )}^{{s}_{j}} \cdot {p}_{j}^{{f}_{j}} , \qquad ( Equation 3 )$$

where 1− [symbol] _{iεT}_{ⱼ}(1−lᵢ)=pⱼ (Equation 1 above) represents the loss rate observed at client Cⱼ.

In an embodiment of the invention, Equation 2 can be solved indirectly by sampling the posterior distribution. This sampling may be accomplished by constructing a Markov chain whose stationary distribution equals P(θ|D). This technique belongs to a general class of techniques known as Markov Chain Monte Carlo. When such a Markov chain is run for a sufficiently large number of steps, known as the “burn-in” period, it “forgets” its initial state and converges to its stationary distribution. Samples are the taken from this stationary distribution.

To construct a Markov chain (i.e., to define its transition probabilities) whose stationary distribution matches P(θ|D), the analysis program 72 uses Gibbs sampling. The rationale behind using Gibbs sampling is that, at each transition of the Markov chain, only a single variable (i.e. only one component of the vector θ) is varied. The analysis program 72 uses Markov Chain Monte Carlo with Gibbs sampling as follows in an embodiment of the invention. The analysis program 72 starts with an arbitrary initial assignment of link loss rates, l_{L}. At each step, the analysis program 72 picks one of the links, say i, and computes the posterior distribution of the loss rate for that link alone conditioned on the observed data D and the loss rates assigned to all other links (i.e., [symbol] \overline{lᵢ} [symbol] = [symbol] _{k≠i}lₖ. Note that {lᵢ}∪ [symbol] \overline{lᵢ} [symbol] =l_{L}. Thus,

$$P ( {l}_{i} \vert D , \{ {\overline{l}}_{i} \} ) = \frac{P ( D \vert \{ {l}_{i} \} ⋃ \{ {\overline{l}}_{i} \} ) P ( {l}_{i} )}{{\int }_{i}^{} P ( D \vert \{ {l}_{i} \} ⋃ \{ {\overline{l}}_{i} \} ) P ( {l}_{i} ) ⅆ {l}_{i}} \qquad ( Equation 4 )$$

We let {lᵢ}∪ [symbol] \overline{lᵢ} [symbol] =l_{L} and illustrate the Gibbs sampling procedure assuming P(l_{L}) is proportional to 1. As one skilled in the art can appreciate, one can use other prior distributions in which P(l_{L}) is not proportional to 1. When P(l_{L}) is proportional to 1 following relationship can be developed:

$$P ( {l}_{i} \vert D , \{ {\overline{l}}_{i} \} ) = \frac{P ( D \vert {l}_{L} )}{{\int }_{i}^{} P ( D \vert {l}_{L} ) ⅆ {l}_{i}} \qquad ( Equation 5 )$$

Using Equations 4 and 5, the analysis program 72 computes the posterior distribution P [symbol] lᵢ|D, [symbol] \overline{lᵢ} [symbol] [symbol] and draws a sample from this distribution. Since the probabilities involved may be very small and could well cause floating point underflow if computed directly, it may be preferable for the analysis program 72 to perform all of its computations in the logarithmic domain. Performing this computation gives a new value, l′ᵢ, for the loss rate of link i. In this way, the analysis program 72 cycles through all of the links and assigns each a new loss rate. The analysis program 72 iterates this procedure several times. After the burn-in period, the analysis program 72 obtains samples from the desired distribution, P(l_{L}|D). The analysis program 72 uses these samples to determine which links are likely to be lossy.

In general, the analysis program 72 begins by measuring the number of successful and failed packet transmissions to each end node. Then, the analysis program 72 chooses a loss rate for each link, except for one of the links, i. The loss rates may be chosen in a variety ways, including randomly. The analysis program 72 then expresses the probability distribution of P(D|lᵢ) as a function of lᵢ. Using Equation 3,

$$P ( D \vert {l}_{i} ) = {\prod }_{j ∈ clients}^{} {( 1 - {p}_{j} )}^{{s}_{j}} \cdot {p}_{j}^{{f}_{j}} ,$$

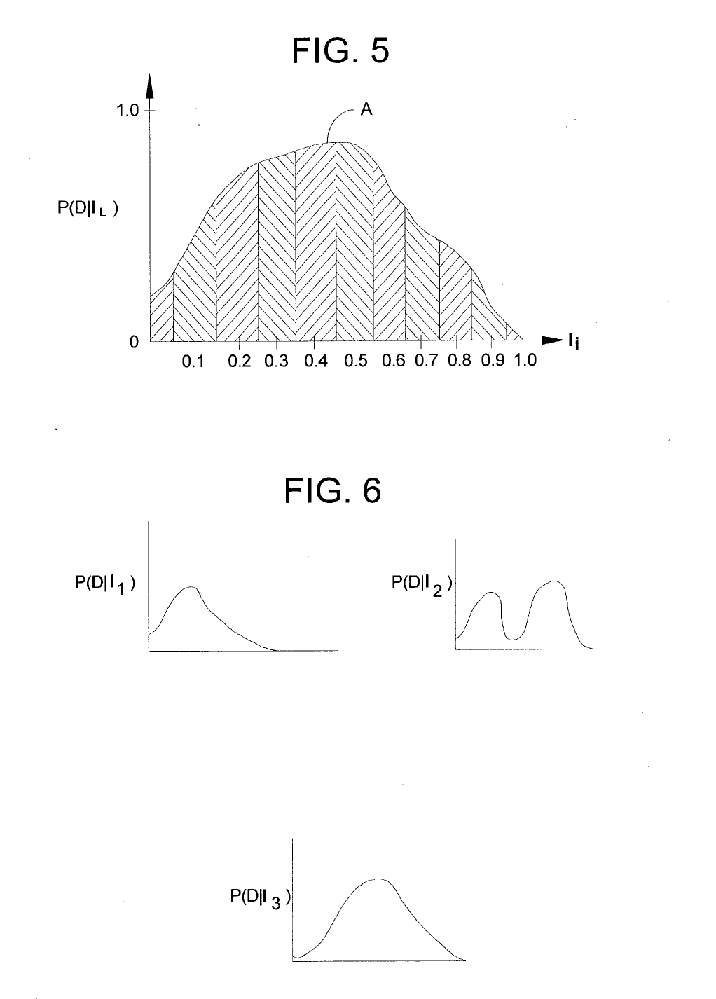

and expressing pⱼ in terms of lᵢ, the analysis program 72 obtains the function ƒ(lᵢ), which is equal to P(D|lᵢ). The analysis program 72 then calculates an approximate distribution over values of lᵢ by normalizing the functions ƒ(lᵢ) and samples a value for lᵢ from this distribution. To illustrate, reference is made to FIG. 5, in which an example of a graph having a curve that represents a function ƒ(lᵢ) is shown. The area under the curve represents the value of the integral

$${\int }_{0}^{1} f ( {l}_{i} ) ⅆ {l}_{i} .$$

The x-axis of the graph ranges from lᵢ equals zero to one with ten increments of 0.1. The area of an individual column divided by the total area under the curve each represents the probability of drawing a sample of P [symbol] lᵢ|D, [symbol] \overline{lᵢ} [symbol] [symbol] for ranges of lᵢ associated with that column. For example, the area under column A divided by the total area represents the probability of obtaining a sample for P [symbol] lᵢ|D, [symbol] \overline{lᵢ} [symbol] [symbol] for 0.35≦lᵢ<0.45. The actual value of the sample is drawn uniformly within this region. The analysis program 72 then repeats this procedure over a number of iterations, and using different links as the “variable” links. For a first set of iterations, known as the “burn-in period,” the analysis program 72 does not record the samples taken for P [symbol] lᵢ|D, [symbol] \overline{lᵢ} [symbol] [symbol] . The burn-in period may comprise any number of iterations, but typically a 1000-iteration burn-in period is effective. After the analysis program 72 has completed the burn-in period, it repeats the procedure for a second set of iterations (such as 1000), records the values for the samples of P [symbol] lᵢ|D, [symbol] \overline{lᵢ} [symbol] [symbol] for each link, and, based on the samples, develops a separate probability distribution for each link. For example, the network shown in FIG. 3 has link loss rates l₁, l₂ and l₃. Because we are using a Gibbs Sampling technique, the analysis program 72, upon completing the procedure, the samples collected for each link are samples from the distributions P [symbol] l₁|D [symbol] , P [symbol] l₂|D [symbol] and P [symbol] l₃|D [symbol] . By sampling enough points we effectively can capture all-important aspects of these distribution. Referring to FIG. 6, examples of such distributions are shown.

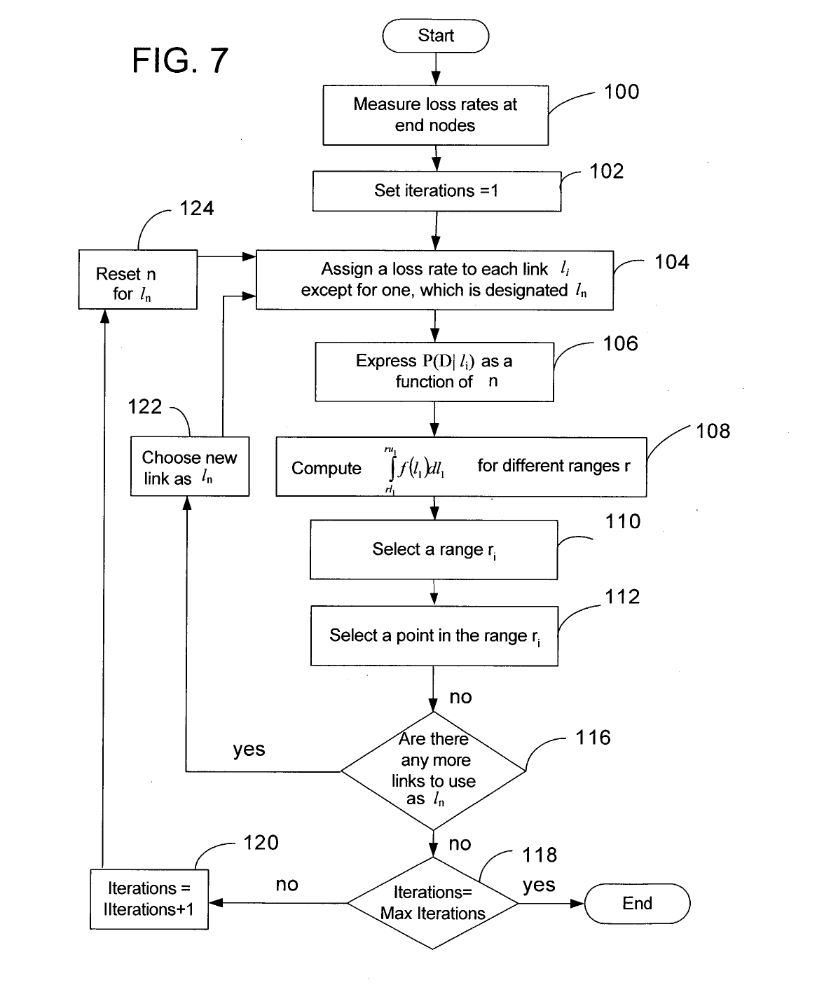

A more specific example of how the analysis program 72 of FIG. 3 determines which links are lossy will now be described with reference to the flowchart of FIG. 7. At step 100, the analysis program 72 measures the loss rates at the second and third client computers 54 and 56. In this example, it is assumed that, according to the measurements taken by the analysis program 72, the number of packets that succeed in reaching the second client computer 54 is 10, while the number of packets that are lost somewhere between the server 50 and the second client computer 54 is two (2). It is also assumed that the number of packets that succeed in reaching the third client computer 56 is 15, while the number of packets that are lost somewhere between the server 50 and the third client computer 56 is five (5). At step 102, the analysis program 72 sets a counter called “Iterations” to 1. The Iterations counter enables the analysis program 72 to keep track of how many passes through the outer loop it has performed. At step 104, the analysis program 72 assigns a loss rate to each of the links lᵢ except for one, which will be referred to generally as lₙ, where n ranges from 1 to the number of links in the network. In this example, the analysis program 72 assigns a loss rate of 0.5 to the link l₂ and a loss rate of 0.4 to the link l₃, while leaving the loss rate of the link l₁ variable. At step 106, the analysis program 72 expresses P(D|lᵢ) as a function of lₙ. To accomplish this task, the analysis program 72 computes p₁ and p₂ as functions of l₁ and uses the equations of Table 2 above. In this example,

p₁=1−(1−l₁)(1−l₂)=1−(1−l₁)0.5=0.5+0.5l₁

p₂=1−(1−l₁)(1−l₃)=1−(1−l₁)0.4=0.6+0.4l₁

Using Equation 3, P(D|lᵢ)= [symbol] [symbol] 1−p₁ [symbol] ¹⁰·p₁² [symbol] · [symbol] [symbol] 1−p₂ [symbol] ¹⁵·p₂⁵ [symbol] and substituting for P₁ and P₂, the analysis program 72 obtains a function ƒ(l₁) that is equal to P(D|lᵢ):

P(D|lᵢ)=ƒ(l₁)= [symbol] (0.5−0.5l₁) ¹⁰·(0.5+0.5l₁)² [symbol] · [symbol] (0.4−0.4l₁)¹⁵·(0.6+0.4)⁵

[symbol]

At step 108, the analysis program 72 computes the integral

$${\int }_{r {l}_{1}}^{{ru}_{1}} f ( {l}_{1} ) ⅆ {l}_{1}$$

for different ranges r (r₁, r₂. . . rₙ) of the links lₙ where a range consists of an upper and lower value. The values of the integrals for these ranges are w₁, w₂. . . wₙ, respectively (n>10 is desirable). Next, at step 110 a range rᵢ is chosen using a distribution obtained from the weights (w), by dividing by the sum of the weights. Then a point is uniformly chosen from the range in step 112. The sample obtained represents a value of l₁. At step 116, the analysis program 72 determines whether there are any more links that can be used as lₙ in steps 104-110. If so, then the analysis program 72 proceeds to step 122, at which it chooses a new link to be lₙ. Thus, in this example, the analysis program 72 repeats steps 104-110 using lₙ where n equals one, two and three, and obtains samples from P [symbol] lᵢ|D, [symbol] \overline{lᵢ} [symbol] [symbol] for i=2,3,etc. If, at step 116, the analysis program 72 determines that there are no more links in the network that have not yet been used as lₙ, then the analysis program 72 proceeds to step 118, where it compares the current value of Iterations with MaxIterations. If they are equal, then the analysis program 72 considers the procedure to be complete. If they are not equal (i.e. there are still more iterations left), then the analysis program 72 proceeds to step 120, at which it increments the value of Iterations by 1. The analysis program 72 then proceeds to step 124, at which it resets the value of n (e.g., sets it back to one), so that it can, once again, perform steps 104-110 using each link as lₙ.

Once the analysis program 72 obtains a distribution P(lᵢ|D) for each i, the analysis program 72 makes an assessment regarding which links of the network are lossy based on the distributions. This assessment may be made in accordance with a number of different criteria. For example, the analysis program 72 may deem a link in which 90 percent of the probability distribution of its loss rate is above 0.4 to be lossy. In another example, the analysis program 72 may compute the mean or median of a loss rate probability distribution for a particular link and, if the mean or median is greater than a threshold value (e.g., 0.5), the analysis program 72 deems the link to be lossy. In yet another example, a decision theoretic approach can be used in conjunction with specified costs of testing and repairing links to determine a cost-effective sequence of test and repair actions.

It can thus be seen that a new and useful method and system for identifying lossy links in computer network has been provided. In view of the many possible embodiments to which the principles of this invention may be applied, it should be recognized that the embodiments described herein with respect to the drawing figure is meant to be illustrative only and should not be taken as limiting the scope of invention. For example, those of skill in the art will recognize that the elements of the illustrated embodiments shown in software may be implemented in hardware and vice versa or that the illustrated embodiments can be modified in arrangement and detail without departing from the spirit of the invention. Therefore, the invention as described herein contemplates all such embodiments as may come within the scope of the following claims and equivalents thereof.

We claim:

1. In a computer network having a plurality of links and a plurality of client computers, a method of determining which of the plurality of links are lossy, the method comprising:
obtaining packet loss statistics at each of the plurality of client computers;
computing posterior probabilities over the loss rates for each of the plurality of links; and
deciding whether a link is lossy based at least in part on the posterior probabilities.

2. The method of claim 1 where the posterior probabilities for a link includes a set of sample loss rates for the link and the set is computed by sequentially fixing the loss rates of all but one of the links, randomly sampling the loss rate for the unfixed link and storing the sampled values as the set of values.

3. In a computer network having a plurality of links and a plurality of client computers, a method of determining which of the plurality of links are lossy, the method comprising:
gathering packet loss statistics at least one of the plurality of client computers;
fixing the loss rates of all but one of the links of the plurality of links;
determining a distribution of probabilities of the occurrence of the obtained packet loss rates given one or more loss rates for the link whose loss rate was designated as being variable;
sampling the mathematical distribution; and
based on the sampling step, determining whether the link whose loss rate was designated as being variable is lossy.

4. A computer-readable medium having stored thereon computer-executable instructions for performing the method of claim 1.

5. The method of claim 1, wherein the steps of claim 1 are performed in a first iteration, the method further comprising:
in a second iteration,
designating the loss rate of another link of the plurality of links as being variable;
fixing the loss rates of the rest of the links of the plurality of links, including the loss rate of the link that had previously been designated as variable in the first iteration;
computing a second mathematical distribution, the second mathematical distribution representing the probability of the occurrence of the obtained packet loss rates given one or more loss rates for the link whose loss rate was designated as being variable in the second iteration; and
sampling the second mathematical distribution.

6. The method of claim 1, further comprising:
repeating the obtaining, designating, fixing, computing and sampling steps over a plurality of iterations; and
varying, over the course of the plurality of iterations, which link of the plurality of links is designated as variable.

7. The method of claim 1, further comprising:
repeating the obtaining, designating, fixing, computing and sampling steps over a first plurality of iterations;
disregarding the data acquired over the first plurality of iterations;
repeating the obtaining, designating, fixing, computing and sampling steps over a second plurality of iterations;
compiling, over the course of the second plurality of iterations data that allows the creation of a probability distribution of the loss rate for each of the plurality of links; and
determining which links of the plurality of links is likely to be lossy based on the probability distribution of the loss rate for each of the plurality of links.

8. The method of claim 1, wherein the obtaining, designating, fixing, computing and sampling steps are performed at a single computer on the network.

9. The method of claim 1, wherein the obtaining, designating, fixing, computing and sampling steps are performed at multiple computers on the network.

10. A method for determining data loss rates for a plurality of links in a computer network, the computer network having a server and a plurality of client computers, wherein l_{L} is the loss rates of all of the plurality of links, lᵢ represents the loss rate of a particular link of the plurality, and [symbol] \overline{lᵢ} [symbol] are the loss rates of each of the links of the plurality other than the particular link, and wherein {lᵢ}∪ [symbol] \overline{lᵢ} [symbol] =l_{L}, the method comprising:
observing the end-to-end loss rates, D, between the server and at least some of the plurality of client computers;
choosing a link of the plurality to have a loss rate of lᵢ;
assigning values to [symbol] \overline{lᵢ} [symbol] ;
numerically computing the posterior distribution P(lᵢ|D, [symbol] \overline{lᵢ} [symbol] ); and
drawing a sample from the posterior distribution P(lᵢ|D, [symbol] \overline{lᵢ} [symbol] ); and
based on the drawn sample, determining whether the chosen link is lossy.

11. A computer-readable medium having stored thereon computer-executable instructions for performing the method of claim 10.

12. The method of claim 10, further comprising:
varying which link of the plurality links is chosen to have a loss rate of lᵢ; and
for each link that is chosen to have a loss rate of lᵢ, repeating the computing and drawing steps for each resulting posterior distributions P(lᵢ|D, [symbol] \overline{lᵢ} [symbol] ).

13. The method of claim 10, further comprising:
repeating the choosing, assigning, computing and drawing steps over a plurality of iterations, wherein each iteration results in a data point being obtained, the data point representing the probability of the loss rate of the chosen link being a certain value given the loss rates of all of the other links of the plurality of links being certain other values,
and wherein, after the plurality of iterations, the resulting data points are compiled into a plurality of probability distributions, each probability distribution corresponding to a link of the plurality of links.

14. The method of claim 13, further comprising:
determining, based on the plurality of probability distributions, which links of the plurality are lossy.

15. The method of claim 14, wherein the determining step comprises determining how much of each of the plurality of probability distributions lies past a particular threshold, and if at least a certain percentage lies past the particular threshold, then designating the link associated with that probability distribution as lossy.

16. The method of claim 14, wherein the determining step comprises determining whether the mean of each of the plurality of probability distributions lies below a particular threshold, and if the mean lies below the particular threshold, then designating the link associated with that probability distribution as lossy.

17. The method of claim 13, wherein decision theory is used in conjunction with the probability distributions and specified costs of testing and repairing links to determine a cost-effective sequence of test and repair actions.
